(19) United States
(12) Patent Application Publication
(10) Pub. No.: US 2014/0114878 A1
(43) Pub. Date: Apr. 24, 2014

(54) MOBILE MEETING PROCESSING

(71) Applicant: SUNGARD DATA SYSTEMS INC., Wayne, PA (US)

(72) Inventors: Jon S. Bluth, San Clemente, CA (US); Rajesh S. Anneswamy, Bangalore (IN); Eileen Van Scoy, Chester Springs, PA (US)

(73) Assignee: SUNGARD DATA SYSTEMS INC., Wayne, PA (US)

(21) Appl. No.: 13/654,965

(22) Filed: Oct. 18, 2012

(51) Int. Cl. G06Q 40/06; G06F 17/20

(52) U.S. Cl. CPC G06Q 40/06; G06F 17/20
USPC 705/36 R; 715/273

(57) ABSTRACT

A system aggregates data that may be used during the course of a scheduled meeting and allows for the customization of the data for presentation during the scheduled meeting. The system communicates the customized data to meeting participants for discussion and review. The system also accepts inputs during the meeting that define additional meeting information such as bookmarked pages and views that were reviewed during the meeting. The inputs may further define notes reflecting discussions held during the meeting. The system stores information reflecting the bookmarks and notes that were made during the meeting. After the meeting has concluded, the data that was presented during the meeting as well as the bookmarks and notes that were presented during the meeting may be reviewed and selected for inclusion in an electronic document. The document may then be electronically communicated to the participants in the meeting for reference at a later time.

### BACKGROUND

Meetings are an essential activity in virtually every business. Whether the business relates to technology research, accounting, marketing, financial planning, or any other pursuit, meetings are often an essential activity in making progress toward an objective.

Meeting participants typically share and review materials together. For example, in the context of a meeting relating to technical research and development, materials relating to test plans and test results may be reviewed and discussed. In another example scenario, in the context of a meeting relating to accounting issues, materials relating to invoices, receipts, and taxes may be reviewed and discussed. In yet another example scenario, a meeting relating to wealth management may involve reviewing materials relating to existing investment portfolios and proposed alternative investment allocations.

Materials that participants wish to review during a meeting may have been prepared in connection with activities other than the meeting. Accordingly, the meeting materials may have a format that is less than desired for use in connection with the meeting. For example, in a scenario wherein a meeting is to take place with upper management of a medical device maker in order to apprise management of the status of various research and development projects, a presenter may wish to present technical testing materials that are typically prepared and formatted for review by scientists and engineers as opposed to management. In another scenario, a wealth management professional may wish to review with a client various charts that are typically prepared and formatted for review by finance professionals as opposed to wealth management clients. In such scenarios, the formatting of the materials may be less than optimal for the intended meeting participants. The meeting participants may be required to review documents that contain significant portions that are not applicable to the meeting and/or not formatted for the particular meeting.

Meeting participants may wish to present on topics that draw on several different source materials. As a result, the materials that are reviewed and discussed at meetings frequently have different formats and fail to suggest a unified presentation. For example, in an illustrative scenario, an accountant may wish to discuss materials from a government study, recent tax returns, and data regarding recent accounts receivable. In another example scenario, a wealth management professional may wish to draw upon data that originates from two different software applications and which is reported in two different formats. The various data types have different formats and when combined give the impression of being disjointed.

During the course of a meeting, participants may discuss various topics and scenarios. The meeting may result in great collaborative efforts where new ideas are exchanged and solutions generated. Such collaborative advances may be forgotten and lost, however, once the meeting is completed. The specific discussions and scenarios presented during a meeting may be remembered for only a short time but eventually fade with memories.

### SUMMARY

Applicants have developed systems and methods that enhance the sharing of information between meeting participants and preserve the collaborative work product generated during meetings. The systems and methods disclosed herein may have application in a wide range of industries and may be applied to any number of meeting situations. In one example scenario that is referred to at several points in this description, the systems and methods are applied to the business of wealth management and to the preparation for and meeting with wealth management clients. It should be appreciated that the disclosed systems and methods may be applied to other businesses and meeting types outside of those specifically described herein.

In an example embodiment, a system for gathering and formatting meeting content comprises at least one computing server. The server is programmed to provide various functions including, for example, retrieving data that may be used during a meeting, formatting the data for a meeting, communicating the formatted meeting data, capturing and storing materials generated during the meeting, and generating a document preserving the information presented and generated during the meeting. The server is communicatively coupled with a computing storage to which data and information relating to meetings may be stored and from which such data may be retrieved. The server may be communicatively coupled to one or more systems from which data and information relating to a meeting may be retrieved. The server may also be communicatively coupled with client devices such as, for example, portable computing devices to which meeting information may be communicated and from which inputs and requests may be received.

In an example embodiment, the server may receive an input indicating a meeting has been scheduled. The input may specify information about the meeting that will allow the system to retrieve information that is relevant to the meeting. For example, the input may specify that the meeting is scheduled to take place with a particular person and/or regarding a particular item or topic. In an example scenario, the input may specify that a meeting with a particular wealth management client has been scheduled.

In response to the input identifying a scheduled meeting, the server communicates with the one or more servers that contain data that may be relevant to the scheduled meeting. For example, the server may send a request for data relevant to a particular person or a particular topic. In an example scenario, the server may communicate an identifier corresponding to a person with whom a wealth management meeting has been scheduled.

The server then receives data from the one or more systems relevant to the topic that was identified in the request. The received information may be in any useful format and may contain any type of information. For example, the received information may be data retrieved from a database and may relate to a particular topic or person. The received information may contain documents, images, or any other type of data. In an example scenario, the server may receive data relating to existing investments for a particular individual.

The server is adapted to format the received data in order to place it in condition for the scheduled meeting. The formatting may be any actions taken with respect to the data in order to prepare it for review at the scheduled meeting. In an example scenario, the server may be adapted to format received data relating to investments of a particular individual into various pages including charts illustrating the contents of the existing investments.

The server is further adapted to receive inputs formatting the received data for inclusion in the meeting materials. For example, the server may be programmed to receive inputs removing particular data, screens, and/or pages from the materials to be presented during the meeting. The server may receive inputs specifying particular data views or pages to be included in the meeting materials. In an example scenario wherein the received data relates to an individual's investment portfolio, the received inputs may specify particular views of the data to be included in the meeting materials. The server stores data in the data store preserving the inputs identifying the formatting.

The server is programmed to communicate the formatted data to an intended recipient. The data may be communicated in any format that will allow for it to be received and displayed at the target device. In an example scenario, the data is communicated in a format for receipt and display on a mobile device such as, for example, an iPad or similar device. The server may simultaneously communicate the data to more than one device.

During the course of the meeting, inputs may be received at the server specifying information reflective of the meeting discussions. For example, a request may be received indicating that a particular page that is displayed should be bookmarked. In another example, an input may be received identifying a note that was made by one of the participants to the meeting. The server stores information in the database preserving the input. For example, the server may store data identifying that a particular page that was viewed and bookmarked. The server may store data identifying the content of the note and the particular page that was displayed when the note was made.

At the conclusion of the meeting, the database contains a record of the materials reviewed during the meeting and any special inputs such as bookmarks and notes that created during the course of the meeting. The server may subsequently receive inputs identifying particular data items including, for example, pages that should be included or removed from a document recording the meeting materials. The inputs are recorded in the database. After the conclusion of the meeting and receipt of formatting inputs, the server generates a summary document that provides a synopsis of the materials from the meeting that were identified for inclusion into the electronic document. Accordingly, the disclosed service provides for preserving the materials that were presented during the meeting and any bookmarks and notes information that was generated during the course of the meeting.

According to another aspect of the disclosed systems, the server may be adapted to communicate the electronic document. The document may be stored in any number of formats. In an example scenario, the document may be stored in portable document format, i.e., pdf. In an alternative embodiment, the document may be stored as a Microsoft Word document. The server analyzes the document in response to a request to review the document. In an example scenario, the server may analyze the document in order to determine the number of pages in the document. The server then converts one or more pages in the document into individual image files. For example, the server may convert pages that are stored in the pdf document into image files that are formatted consistent with the portable network graphic, i.e., .png file format, or any image format consistent with the disclosure herein. The number of pages that are converted into image files may vary depending upon the particular application. For example, in an example scenario, five pages that are included in the electronic document may be formatted as image files. The converted image files are then communicated to the device or individual that requested the document.

In an example scenario, the server may generate references to all pages in the document and generate thumbnail images for all document pages. The references and images may be communicated to the device from which the request was made. When a request is received for a particular page, the system converts the page to an image file such as a .png image, or retrieves a cashed image file, and communicates the image file.

Converting pages in a document that is stored in pdf format or Word format into image files rather than downloading the source file minimizes the risk that a document containing sensitive information may be copied and/or viewed by unauthorized individuals. In some instances, converting documents into individual images and downloading images, rather than all pages of the entire document, minimizes the communication bandwidth that is used in communicating the relevant document pages.

Documents and any portions thereof that are stored on a user device may be stored in encrypted format. In one example scenario, the data is encrypted prior to transmission to the document. For example, a user of a device may be required to provide a password, after which the document is encrypted with the password, and the encrypted document communicated and stored. In order to access the document on the local device, it is required to provide the password. In an example embodiment, the document stored on the local device may be automatically deleted after a particular date or if a defined period of time passes and the file has not been accessed.

Meeting management systems and methods consistent with the concepts disclosed herein may be employed in any number of industries and meeting scenarios. Each of these industries and scenarios may have unique circumstances that give rise to particular functionality that is suitable for use in a particular industry and scenario. According to another aspect of the disclosed embodiments, applicants disclose a method developed for use in the scenario of wealth management. More particularly, applicants disclose a method applied to a meeting scenario wherein the impact of various goals have on the value of a financial portfolio. In an example scenario described above, the data retrieved by the server for use in a scheduled meeting comprised investment data for a particular individual. The disclosed system provides the capability during a meeting with the individual to consider the impact of a change in expenses to the long term financial plan of the investor. In an example embodiment, during a meeting with the individual, the server may receive an input specifying a new or changed goal for a particular individual. For example, the goal may be a significant purchase such as a house. In an alternate scenario, the goal may be a charitable contribution. In still another scenario, the outflow may be a planned retirement. Generally, a goal involves a financial outflow that either may be one time or recurring with a particular periodicity. In the case of a purchase of a home or charitable contribution, for example, the outflow may be made once or periodically for the life of a mortgage. In the scenario of retirement, the outflow is likely to be a periodically over a time horizon.

In response to receiving information defining the financial flows associated with a particular goal, the server calculates the impact of the identified goal on the value of an individual's investment portfolio. In an example embodiment, the server calculates an estimated value of the portfolio at particular times in the future assuming that the financial outflows associated with the goal are implemented. The server then communicates feedback to the individual illustrating the impact on the investment portfolio of the identified goal. For example, the server may communicate one or more pages containing charts that illustrate the value of the investment portfolio assuming the goal is implemented.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The foregoing summary and the following additional description of the illustrative embodiments may be better understood when read in conjunction with the appended drawings. It is understood that potential embodiments of the disclosed systems and methods are not limited to those depicted.

FIG. 1 depicts a network diagram of an illustrative meeting management system.

FIG. 2 depicts a diagram of functional components of an illustrative meeting management system.

FIG. 3 depicts a flow diagram of an example process for meeting management.

FIGS. 4-9 depict illustrative user interfaces generated by an illustrative meeting management system.

FIG. 10 depicts a flow diagram of an example process for providing financial planning feedback.

FIGS. 11-16 depict illustrative user interfaces generated by an illustrative meeting management system.

FIG. 17 depicts a flow diagram of an example process for communicating document data.

FIG. 18 is a block diagram of an exemplary computing environment that may be used to implement the systems and methods described herein.

### DETAILED DESCRIPTION OF ILLUSTRATIVE EMBODIMENTS

Applicants have developed an illustrative system that aggregates data that may be used during the course of a scheduled meeting and allows for the customization of the data for presentation during the scheduled meeting. The system communicates the customized data to meeting participants whereupon the data may be reviewed and discussed. The system also accepts inputs during the meeting that define additional meeting information such as bookmarked pages and views that were reviewed and discussed during the meeting. The inputs may further define notes reflecting discussions held during the meeting. The system stores information reflecting the bookmarks and notes that were made during the meeting. After the meeting has concluded, the data that was presented during the meeting as well as the bookmarks and notes that were presented during the meeting may be reviewed and selected for inclusion in an electronic document. The document may then be electronically communicated to the participants in the meeting for reference at a later time.

Electronically aggregating data prior to the meeting and allowing for customization of the data that is included for presentation during the meeting provides an opportunity to control the content and format of the materials that are presented during the meeting. The format of the meeting materials can be controlled so as to provide a more unified and consistent presentation format. Furthermore, the recordation of views presented during the meeting and notes of the discussions held during the meeting preserve the collaborative efforts of the meeting participants.

Example Computing Arrangement

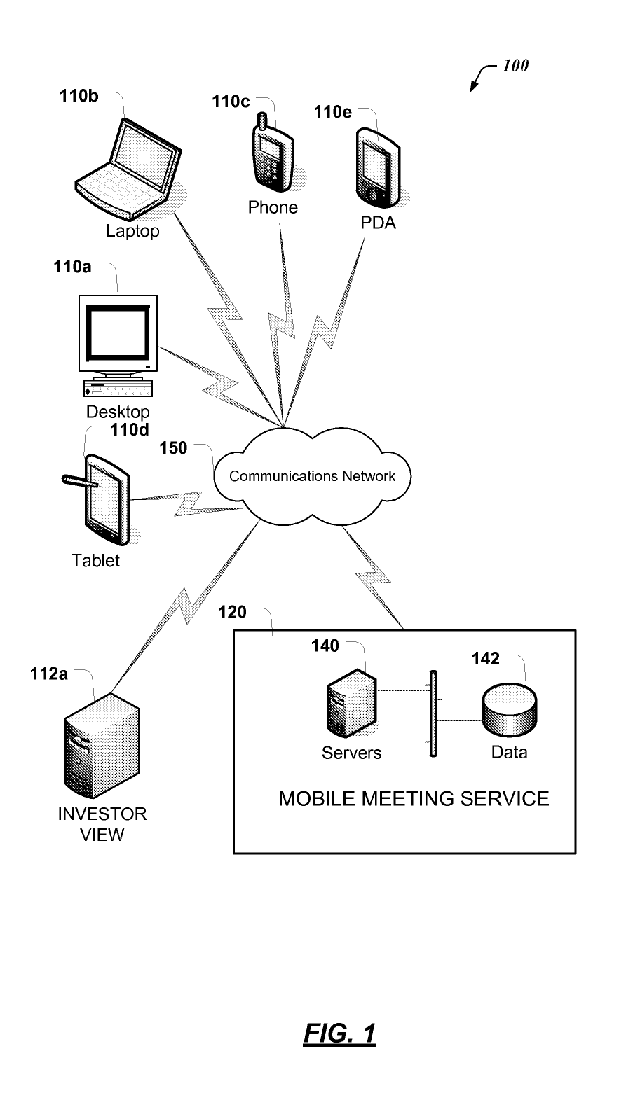

FIG. 1 illustrates an exemplary computing system 100 suitable for providing meeting management. Meeting management service 120 is adapted to aggregate data that may be used during the course of a scheduled meeting, allow customization of the data for presentation during a scheduled meeting, and communicate the customized data for use during a meeting. In an example embodiment, meeting management service 120 is adapted to accepts inputs during the meeting that define additional meeting information such as bookmarked pages and notes. After the meeting has concluded, the data that was presented during the meeting as well as the bookmarks and notes that were presented during the meeting may be reviewed and selected for inclusion in an electronic document.

In an example embodiment, service 120 comprises servers 140 which are communicatively coupled with data store 142. Servers 140 may comprise any computing device that is adapted to perform the functionality as described herein including, for example, communicating with external data sources 112 to request and receive data for presentation during a meeting. Servers 140 are communicatively coupled, perhaps using a computing network, with data stores 142. Data stores 142 maintain any data that may be needed to support the functionality described herein. For example, data stores 142 comprise data matching meeting data with the particular individuals participating in the meeting. Data stores 142 also comprise information defining the specific content that is to be presented in the meeting including identification of any particular bookmarks or notes that have been associated with content that is to be presented. Data stores 142 still further comprise information defining the information that was actually shared during the meeting and any bookmarks and/or notes that were created during the meeting. Data stores 142 may comprise any data storage technology that may be adapted to provide the functionality described herein. Any number of servers 140 and data stores 142 may be used to provide meeting management services as described herein.

Service 120 is adapted to receive data for use in meetings from sources 112 via communications network 150. Sources 112 may be any source from which data may be received for use in a meeting. In an example scenario wherein server 120 is being used in connection with a meeting regarding investments and wealth management, source 112 may be an application that manages personal investments and retains information about those investments. In other scenarios sources 112 may be applications and/or storage locations that contain information relevant to the particular meeting. For example, if the meeting relates to accounting, sources 112 may comprise data relevant to accounting and finance. The data may be received from sources 112 at servers 140 in any format that is suitable for processing. For example, data may be received from sources 112 in a format retrieved from a relational database and may be stored in data storage 142 in a relational database format.

Users employ computing devices 110a-e to interface with service 120 via communications network 150. Computing devices 110a-e may be used to interface with service 120 in order to, for example, access the meeting information being stored at storage device 142 and served by servers 140. Devices 110a-e may also be used to input information such as bookmarks and notes in connection with the particular pages that are viewed prior to, during, and after a scheduled meeting. These inputs are forwarded to the server 140 where they are stored in data store 142. In some embodiments, computing devices 110a-e may receive data from server 140. For example, in some circumstances, it may be desirable for a meeting to be planned and conducted entirely locally to a device 110a-e. Locally planning and conducting a meeting may be desirable or necessary where network access to server 140 is not available. In such an instance, meeting data that is used for planning and conducting a meeting is downloaded to the user device 110a-e, and the meeting planned and conducted as described herein, although the data resides on the local device. Meeting documents generated after a meeting has been completed may also be stored on a user computing device 110a-e. In an example embodiment, where meeting data and or meeting documents are stored on a user device 110a-e, the information may be stored in encrypted format. The encrypted data may be automatically deleted from the local device after a period of time passes.

Computing devices 110a-e may be any type of device that is operable to communicate with service 120. For example, computing devices 110a-e may be desktop computers, laptop computers, wireless phones, personal digital assistants, tablet computers, media players, etc. While only five devices are illustrated in FIG. 1, it is understood that service 120 may be accessed via any number of computing devices 110a-e. Computing devices 110a-e may employ any technology that is suitable to interface with service 120 including, for example, Web browser and Internet technology.

Service 120 is accessible via communications network 150. Communications network 150 may be any type of network that is suitable for providing communications between computing devices 110a-e and service 120. Moreover, communications network 150 may comprise a combination of discrete networks which may use different technologies. For example, communications network 150 may comprise local area networks (LANs), wide area networks (WAN's), cellular networks, or combinations thereof. Communications network 150 may comprise wireless, wireline, or combination thereof. In an exemplary embodiment, communications network 150 comprises the Internet and may additionally comprise any networks adapted to communicate with the Internet.

Service 120 may employ a host of network topologies such as client/server, peer-to-peer, or hybrid architectures. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computing device, such as one of devices 110a-e that accesses shared network resources provided by another computer (i.e., a server). A server, such as device 140, is typically a remote computer system accessible over a remote network such as the Internet. The client process may be active in a first computer system, and the server process may be active in a second computer system, communicating with one another over a communications medium and allowing multiple clients to take advantage of the information-gathering capabilities of the server.

Clients and servers communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Uniform Resource Locator (URL) or an Internet Protocol (IP) address is used to identify the server or client computers to each other. Communication among computing devices is provided over a communications medium. In particular, the client and server may be coupled to one another via TCP/IP connections for high-capacity communication.

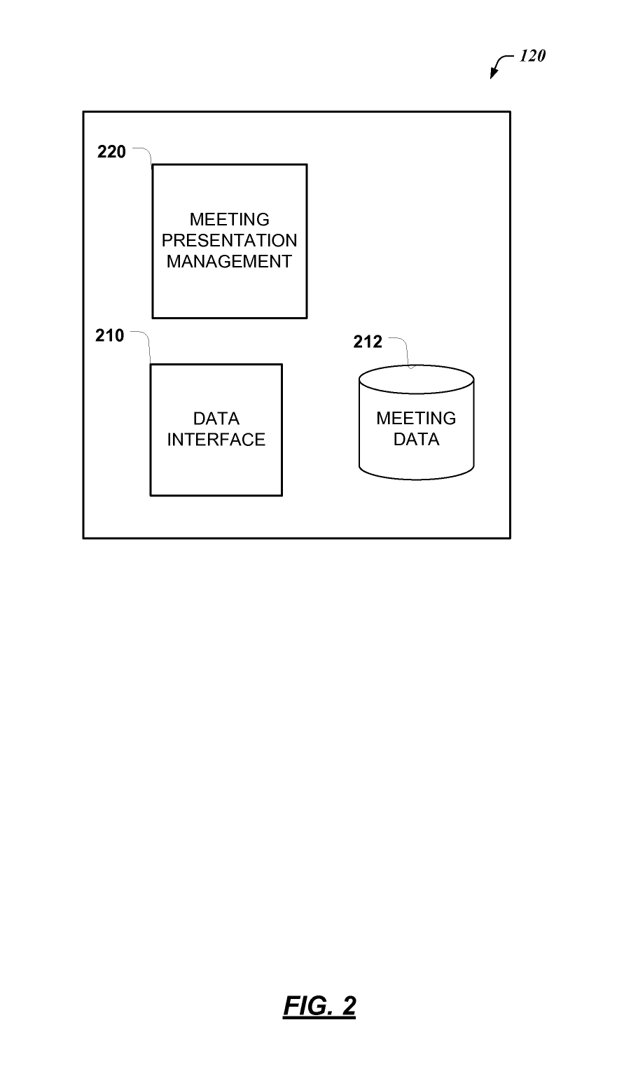

FIG. 2 depicts a block diagram illustrating exemplary logical components of an illustrative service 120 for meeting management. In the example embodiment of FIG. 2, server 120 comprises data feed interface functionality 210, meeting data 212, and meeting presentation management 220. Data feed interface functionality 210 allows for interfacing with external data sources 112 and storing data in data storage 142. For example, in a scenario wherein service 120 is employed to provide meeting regarding wealth management and investments, data feed interface functionality 210 provides for interfacing with sources of individual investment records. For example, data interface functionality 210 may interface with a computing application that is specially designed to store portfolio information for individuals.

Meeting data database 212 represents the functional database operations performed by service 120. Accordingly, meeting data database 212 provides access to the meeting data and related information that specifies the particular information has been identified for inclusion in the meeting. Meeting data may comprise information specifying the information that is to be presented and the format in which the data is to be presented. For example, the meeting data may specify data and a particular page format in which the data is presented. In an example embodiment, the pages may be assigned an identifier that is associated with an identifier corresponding to a particular meeting. Meeting data database 212 may further store and provide access to data specifying which data was actually reviewed during the meeting. The meeting data may identify specific pages that are prepared to be used in a meeting and identify those pages that were actually include. Still further, meeting data database 212 stores information identifying any bookmarks or notes that the meeting participants may have made and associates the bookmarks or notes with particular pages. The data may be stored in any suitable format to achieve the functionality described herein. For example, the data may be stored in a relational database format. Such a format might allow, in an example scenario, assigning each meeting with an identifier in the database and, for data item related to a particular meeting, including an association with the meeting identifier. For example, data to be used in a particular meeting may be stored with an association to the relevant meeting identifier. Similarly, any notes or bookmarks, which may have their own identifiers, are stored with an association to the particular meeting and further with an association to the particular page to which the particular note or bookmark is associated. Storing new data, retrieving previously stored data, and updating data is performed using meeting data database 212. Meeting data database 212 may be implemented by any suitable combination of hardware and software. For example, the functionality may be provided by any number of commercial database software systems.

Meeting presentation management functionality 220 performs any number of management functions in connection with providing meeting management services as described herein. For example, meeting presentation management functionality 220 retrieves data from external sources and forwards the data to meeting data database 212 where it is stored. Meeting presentation management functionality 220 may be adapted to query data in database 212 to identify data that is to be included in a particular meeting and the format in which the meeting data is to be presented. Meeting presentation management functionality 220 further provides for reviewing the data associated with a meeting prior to the meeting and to identifying particular portions of the meeting data to either be included in or excluded from the meeting. Meeting presentation management functionality 220 also communicates the meeting data to the user devices 110a-e during the meeting. Still further, meeting presentation management functionality 220 receives inputs specifying bookmarked pages and notes associated with particular pages and stores corresponding information in database 212.

A typical embodiment may involve meeting data 212 and meeting presentation management functionality 220 being provided by server 140 and data store 142 via a network. In an example embodiment, the system may be versatile to accommodate storing meeting data locally on a user device 110a-e. Likewise, the functionality described herein in connection with preparing for a meeting and conducting a meeting may be done entirely on a user device 110a-e. This feature allows for preparing and conducting meetings even when network connectivity between user devices 110a-e and server 140 is not available. When network connectivity is restored, the system may operate to synchronize any meeting data with the service accessed via network 150.

Meeting Management

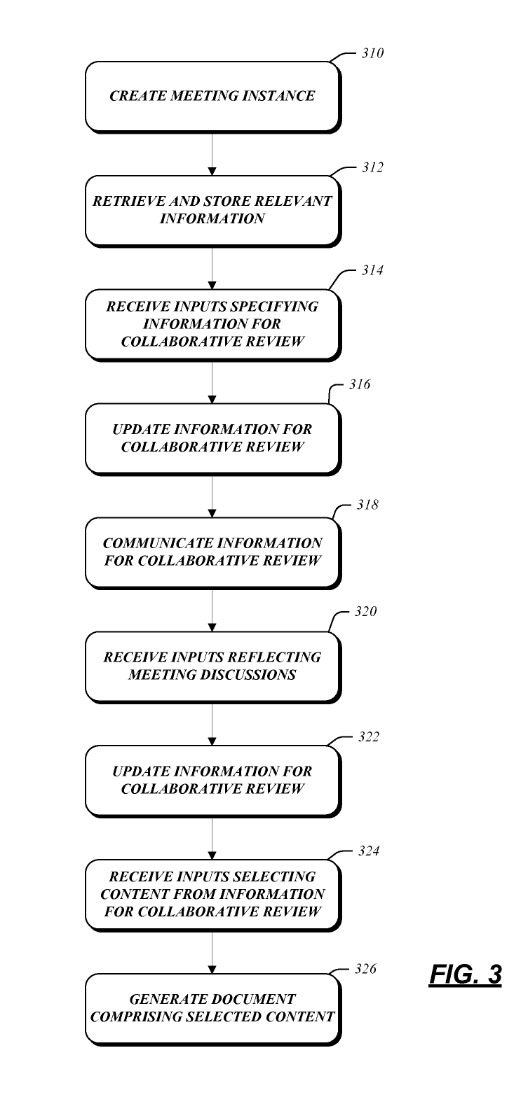

FIG. 3 depicts a flow chart illustrating example functionality provided by meeting management service 120. At step 310, meeting management service 120 creates a meeting instance in data store 142. Service 120 may create a meeting instance, for example, in response to an input indicating that a new meeting has been scheduled. In an example scenario wherein meeting management service 120 is used to manage meetings with wealth management clients, step 310 may involve receiving an indication from a wealth management professional that a meeting has been scheduled with a particular individual. Once an instance for a meeting has been created in data store 142, the data that is subsequently received relating to the meeting can be stored in relation to the meeting instance. In an example scenario, creating an instance in data store 142 may involve creating an instance for the scheduled meeting in a relational database which may include assigning a unique identifier to the meeting. Thereafter, data, meeting pages, bookmarks, and notes may be associated with a meeting by associating the item to the meeting's unique identifier.

At step 312, meeting management service 120 retrieves data relevant to the scheduled meeting from remote data source 112. The particular data source 112 that is accessed and the data that is retrieved are dictated by the particular meeting that has been scheduled. For example, where the meeting relates to a particular individual's investments, data source 112 may be an application and/or storage location where individual investment portfolio data is stored. The received information may be in any useful format and may contain any type of information. For example, the received information may be data retrieved from a database and may relate to a particular topic or person. The received information may contain documents, images, or any other type of data.

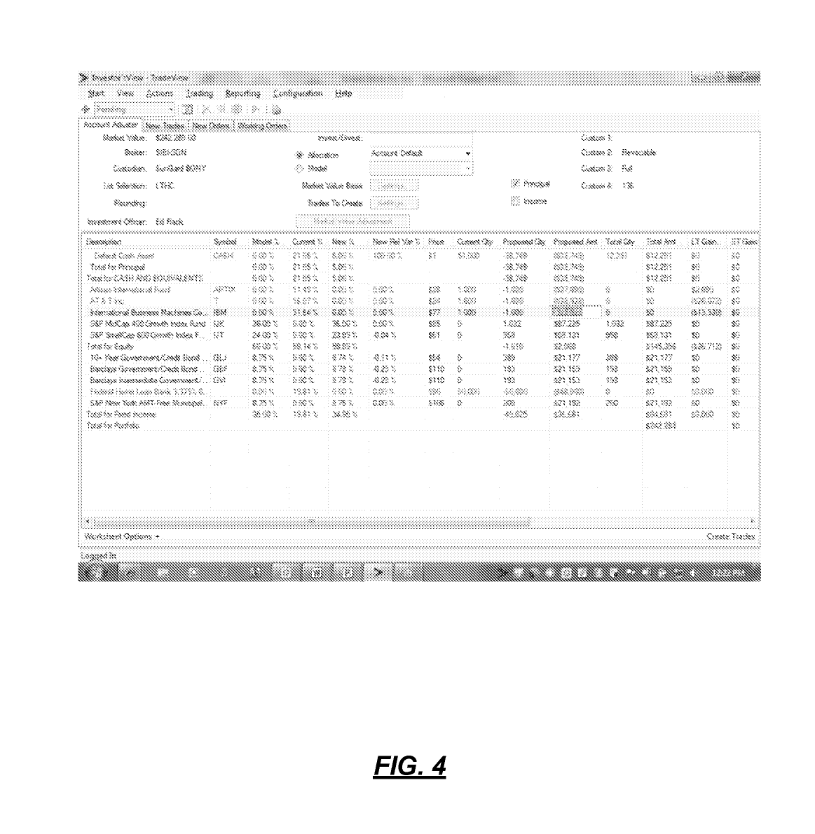

FIG. 4 depicts an illustrative user interface of an application that might be a data source 112. In the computing application depicted in FIG. 4, the application maintains and presents data relative to individuals' investment portfolios. Accordingly, data specifying an individual's investment portfolio is stored and maintained at an external data source 112. Meeting management service 120 requests and receives the relevant data from this data source and stores the data in data storage 142.

Management service 120 is adapted to format the received data in order to place it in condition for the scheduled meeting. The formatting may be any actions taken with respect to the data in order to prepare it for review at the scheduled meeting. In an example scenario, the server may be adapted to format received data relating to investments of a particular individual into various pages which may comprise charts illustrating the contents of the existing investments. The data is stored in data storage 142 in relation to the meeting instance that was created for the particular meeting. In one embodiment, service 120 provides a mode of operation wherein data and functionality are accessed entirely on a local device rather than over a network. In such an embodiment, data may be downloaded to a local device 110a-e, rather than be accessed on a network. In this instance, data storage 142 may be thought of existing on the local device 110a-e. Subsequent processing steps may likewise be performed on a local device 110a-e, rather than on a server 140 accessed via a network. In instances where data is stored and accessed locally, the data is stored in encrypted format.

At step 314, management service 120 receives inputs formatting the received data for inclusion in the meeting materials. For example, the service 120 may be programmed to receive inputs removing particular data, screens, and/or pages from the materials to be presented during the meeting. Service 120 may also receive user inputs specifying particular data views or pages that should be included in the meeting materials. In an example scenario wherein the received data relates to an individual's investment portfolio, the received inputs may specify particular views of the data that are to be included in the meeting materials. In an example embodiment, service 120 allows for creating and maintaining several different versions of a meeting. This allows the operator flexibility in preparing different scenarios with different goals so that the operator is well prepared for the many different avenues that a conversation may take during a meeting. In a mode of operation wherein meeting data is stored on a local device 110a-e, inputs specifying formatting to the meeting data such as bookmarks and notes are likewise stored locally. This feature applies to bookmarks and notes entered by the person planning the meeting materials, but also applies to any information entered by any of the participants to the actual meeting.

At step 316, management service 120 stores data relating to the formatting inputs in data store 142. For example, service 120 may store in data store 142 information identifying that for a particular meeting instance, particular pages should or should not be incorporated into the meeting materials. Notes or bookmarks created by a person preparing for the meeting are stored in data store 142 in relation to the particular page to which the note or bookmark is relevant. Data may be added to the materials to be presented during the meeting by associating the data with the meeting identifier. Similarly, data may be removed from the materials to be presented during the meeting by removing the relationship between the data and the meeting instance.

At step 318, meeting management service 120 communicates the formatted meeting data to an intended recipient in connection with the meeting. The data may be communicated in any format that will allow for it to be received and displayed at the target device. In an example scenario, the data is communicated in a format for receipt and display on a mobile device such as, for example, an iPad or similar device. The communication may be made using any of numerous technologies including, for example, Web related technologies. The server may simultaneously communicate the meeting information to more than one device.

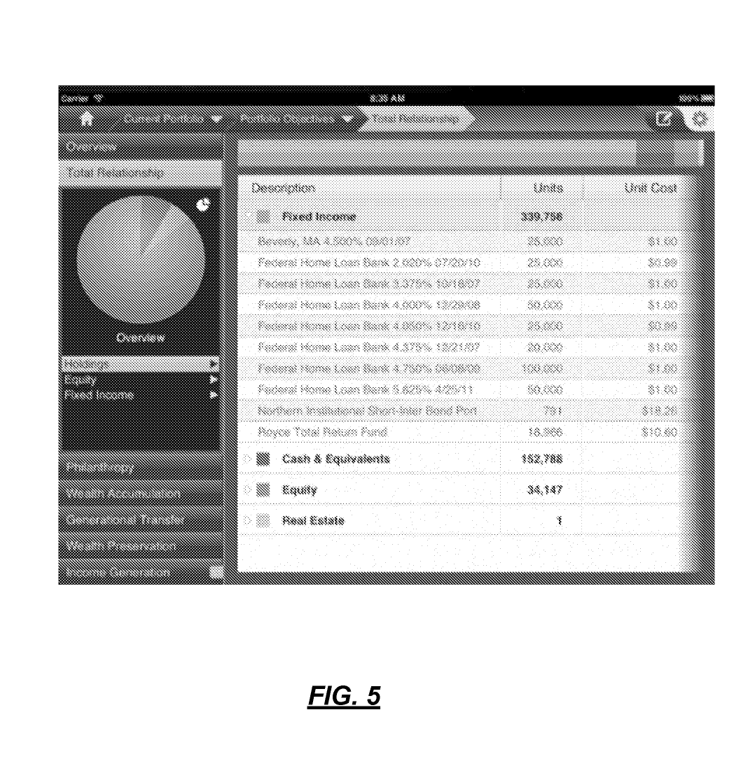

FIG. 5 depicts an example user interface screen that may be generated during the course of a meeting in an illustrative scenario of a wealth management meeting. As shown in FIG. 5, the meeting participants are presented with information about the portfolio of a particular individual. The information that is presented during the meeting is derived from and consistent with the information that was retrieved at step 310.

Referring back to FIG. 3 and step 320, during the course of the meeting, inputs may be received at meeting management service 120 specifying information indicative of the meeting discussions. For example, a user input may be received at service 120 indicating that a particular page that is displayed should be bookmarked. In another example, an input may be received identifying a note that was made by one of the participants to the meeting. In an example embodiment, the inputs may distinguish between “meeting notes” and “user notes.” Meeting notes may be intended for use in the meeting summary document that preserves the meeting discussion. User notes, on the other hand, may be intended for the user's own consumption and not for use in connection with creating the meeting summary.

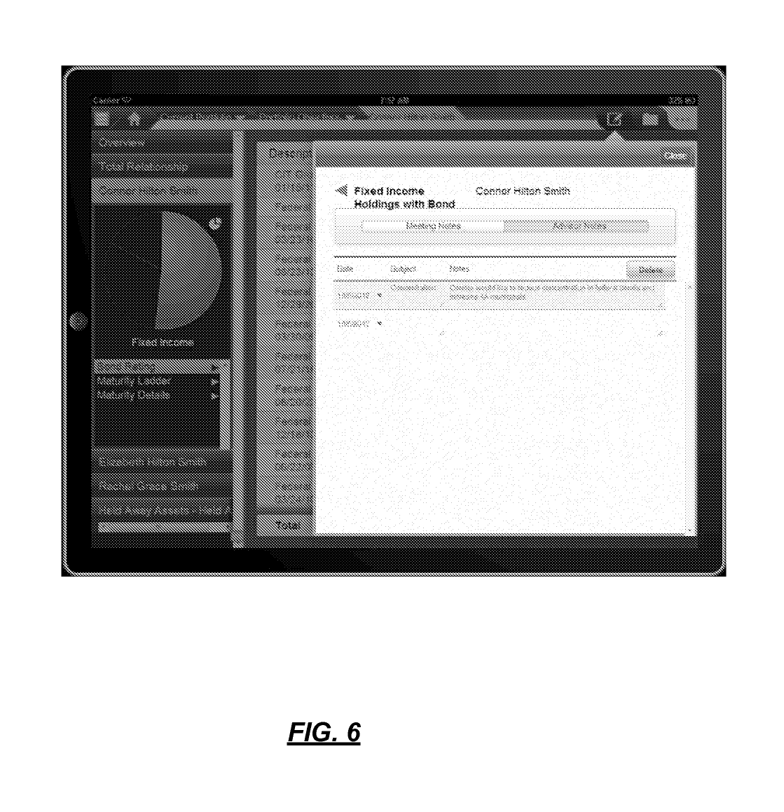

FIG. 6 depicts an example user interface screen that may be generated during the course of a meeting in an illustrative scenario of a wealth management meeting. As shown in FIG. 6, during the course of a meeting, the participants may enter notes and associate those notes with a particular page. In the particular example illustrated in FIG. 6, during a meeting with “Connor Hilton Smith,” a note regarding the subject of “concentration” has been entered and associated with the displayed page.

Referring back to FIG. 3, at step 322 meeting management service 120 stores information in the database 142 preserving any inputs received during the course of the meeting. For example, service 120 may store data identifying that a particular page was viewed and bookmarked. In an example scenario, service 120 may store in data store 142 an identifier identifying a bookmark and associate that identifier with an identifier associated with the particular page. Service 120 may store data identifying the content of a note and the particular page that was displayed when the note was made. For example, service 120 may store in data store 142 an identifier for the note along with the content of the note as well as an association between the note identifier and a page identifier corresponding to the particular page on which the note was made. This information is user subsequently so as to be available when generating a meeting summary document.

At the conclusion of the meeting, database store 142 contains a record of the materials reviewed during the meeting and any special inputs such as bookmarks and notes that may have been created during the course of the meeting. The recorded information provides for generating a document that serves as a record of the meeting. Accordingly, at step 324, service 120 receives inputs identifying particular data items including, for example, pages, that should be included in the summary document or removed from the summary document. The inputs are recorded in database 142 so as to capture the pages and data views that are to be included in the meeting document. The inputs defining the contents of the document may be received from the person that planned the meeting, but may also be input by any of the participants in the meeting. Accordingly, meeting participants can decide which notes and page views they would prefer to see in the final document.

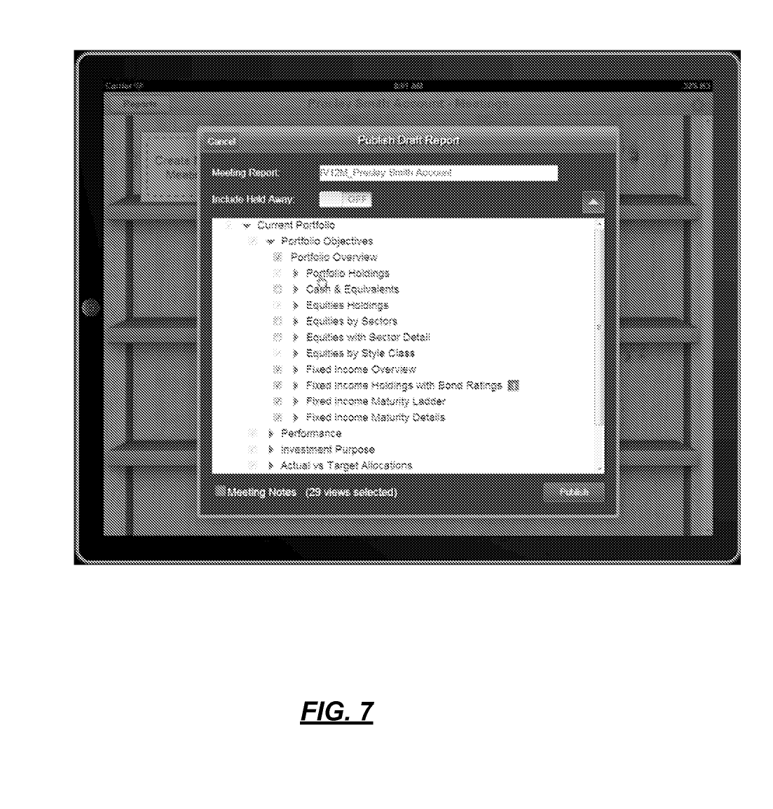

FIG. 7 depicts an example user interface that may be presented by meeting management service 120 to allow operators to select particular information for inclusion in the meeting summary document. As shown, in an example embodiment, a user interface may be presented with meeting pages classified by subject. The operator can indicate that they wish for particular pages that were presented during the meeting to be included in the final document by placing a check mark next to the particular page. The pages that are displayed and available for selection include those views that may have been created during the meeting and which were bookmarked. Notes that were generated and associated with particular pages are included when the associated page is selected for inclusion. The selections made by the operator are recorded in database store 142 to be used in connection with generating the actual meeting document.

Referring back to FIG. 3, at step 326, meeting management service 120 generates a meeting document using the information stored in data store 142. In an example scenario, service 120 may query data store 142 for all of the meeting information that has been designated for inclusion in the meeting document. The document may be formatted in any format that is functionally adequate. In an example scenario, meeting management service 120 may generate a portable document format, pdf, document.

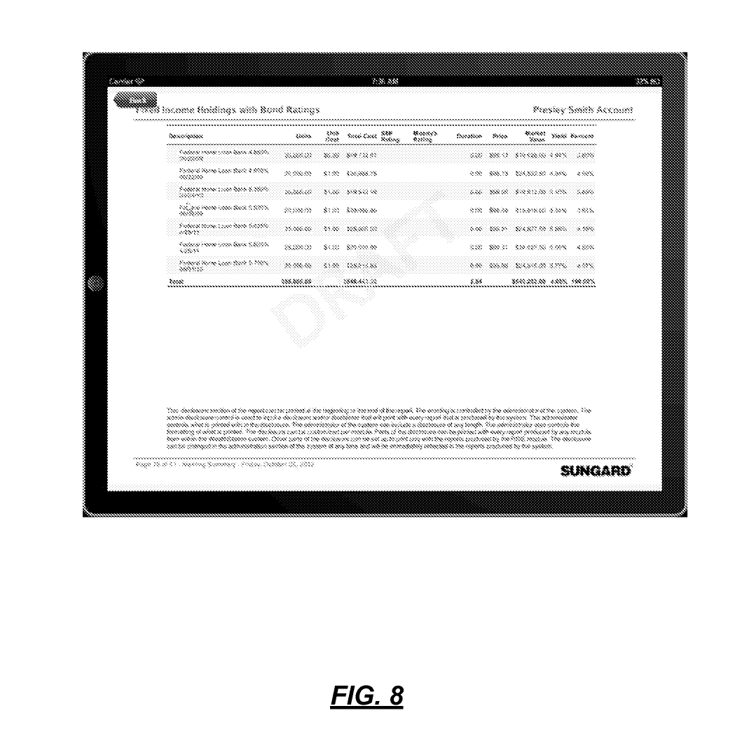

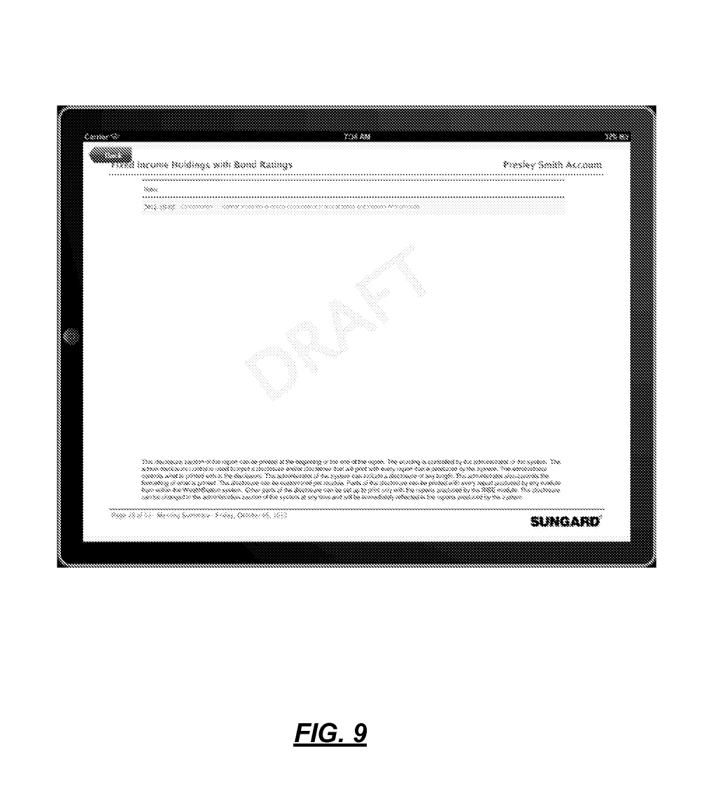

FIG. 8 depicts an illustrative screen displaying an example page in an example meeting document. FIG. 8 depicts a page number 26 of a 53 page meeting summary. The pages of the document reflect the materials that were reviewed during the meeting and selected for inclusion in the document. FIG. 9 depicts an illustrative screen displaying another example page of a meeting document. FIG. 9 illustrates a note that was created during the meeting has been included in the meeting document. In an example embodiment, the notes may be included on a page directly following the page or section with which the note was associated.

As noted above, the concepts of meeting management that are described herein may be applied to numerous different industries and scenarios. One example industry is wealth management. Each industry has specialized topics that may be unique to the particular industry but which are common topics of conversations at meetings in that industry. Meeting management service 120 may be extended to incorporate functionality that applies to particular industries and scenarios. For example, in the context of wealth management, it is possible that during a meeting the participants will discuss various investment goals and the impact those goals may have on the larger investment portfolio.

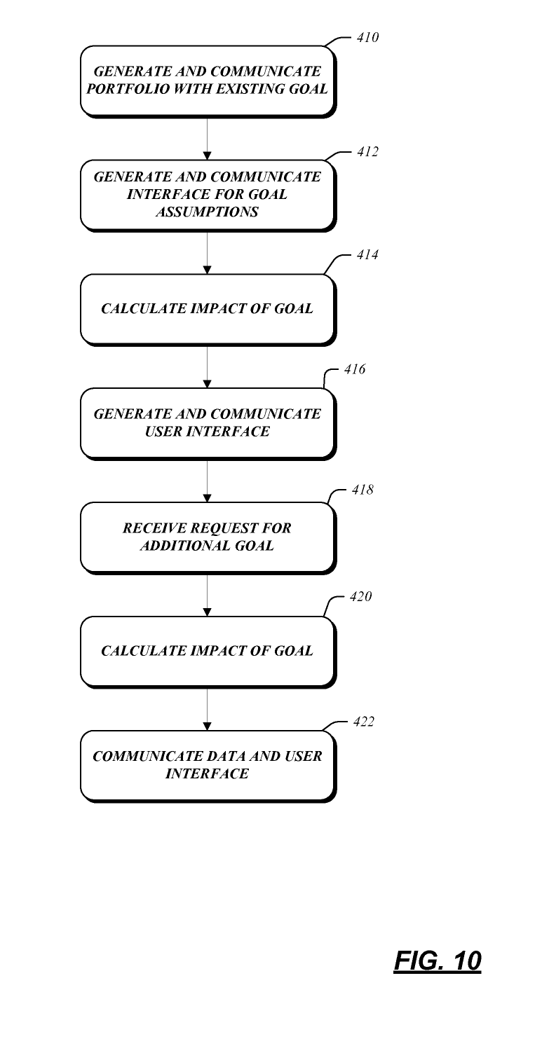

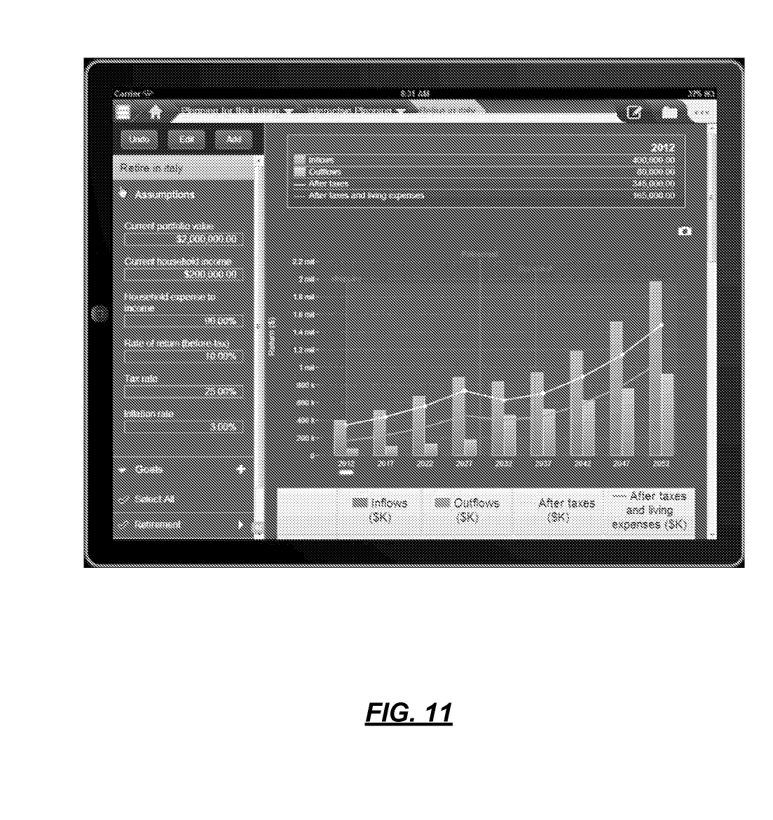

FIG. 10 depicts a flow diagram of example functionality for assessing the impact of various goals and scenarios on an individual's investment portfolio over time. As shown at step 410, meeting management service 120 may generate and present a meeting interface depicting the impact that various goals have on an individual's wealth across time. FIG. 11 depicts an example user interface screen illustrating the impact over time of various goals that have related expenses. In particular, FIG. 11 depicts a scenario whereby the individual retires to Italy. Assumptions relating to the value of the portfolio are shown as well as the impact of the expenses associated with a retirement in Italy are illustrated using bar graphs at various points in the future. As shown, for each of a plurality of future years, bar diagrams represent the inflows and outflows that can be expected. Colored lines identify the value of the portfolio after taxes and after taxes and living expenses. The financial flows associated with the particular goal of retiring to Italy are illustrated on the left side of the page.

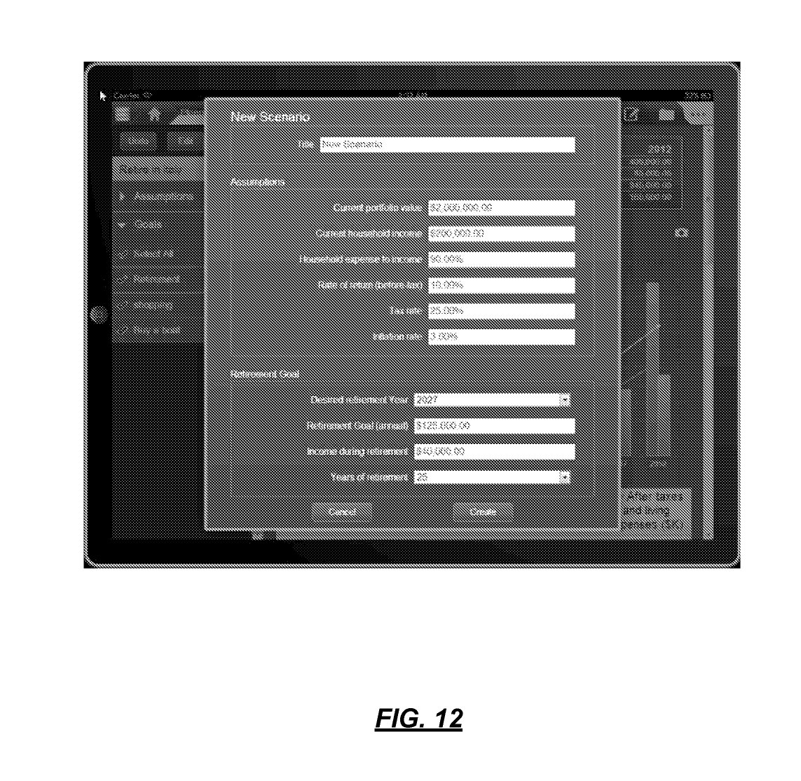

At step 412, meeting management service 120 presents a user interface screen for entry of underlying assumptions relating to a goal. FIG. 12 depicts an example user interface that may be generated and presented during a meeting. As shown, service 120 allows the individual to name a new scenario and to enter various assumptions regarding the scenario or goal. For example, the meeting participant may be able to enter data specifying the following information: a current portfolio value; a current household income; a household expense to income ratio; rate of return (before tax); tax rate; and assumed inflation rate. The assumptions may further comprise values for the following: a desired year of retirement; a goal for annual funds for use in retirement; income during retirement; and expected years of retirement. Once the user has entered this information and clicked on the “create” button, the information entered on the screen is saved by service 120 to database 142.

At step 414, meeting management service 120 calculates the financial impact over time of the assumptions entered by the individual. More particularly, service 120 calculates the value of the individual's portfolio over time given the assumptions that were entered by the individual. In an example embodiment, service 120 stores data relating the impact of the scenario over time in database 142.

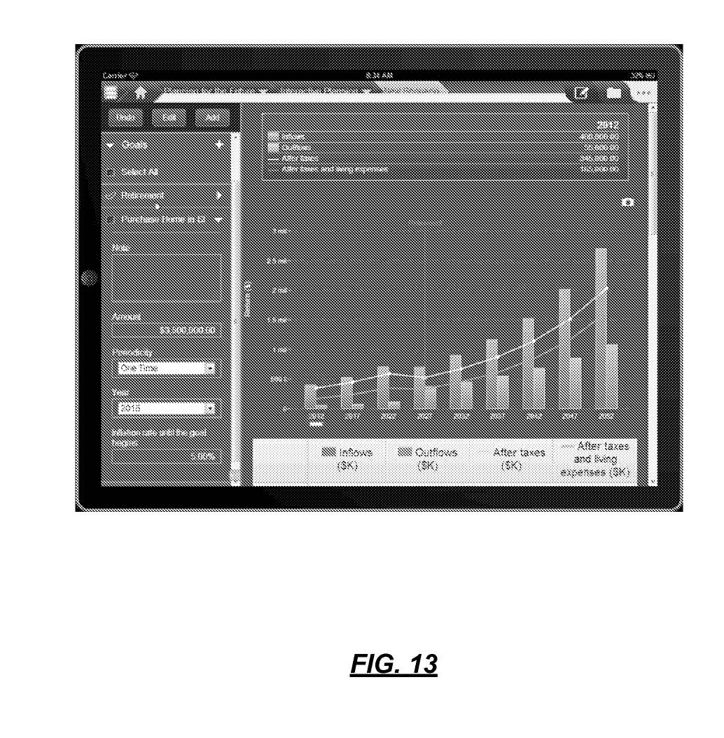

At step 416, meeting management service 120 generates and communicates a user interface depicting the value of the scenario over time. FIG. 13 depicts an example user interface that may be generated and presented. As shown, service 120 provides a chart illustrating the value of the portfolio at various points in time. For each year, inflows and outflows are shown corresponding to the assumptions that the individual previously entered. Also the value of the portfolio is shown for both after taxes and after taxes and living expenses. In the example of FIG. 13, along the left side of the depicted screen the single goal of “retirement” has been selected. The depicted screen offers the possibility to select to see the impact of other goals on the value of the portfolio. In the particular scenario depicted in FIG. 13, it is possible to select to view the impact of pursuing the goal of purchasing a retirement home.

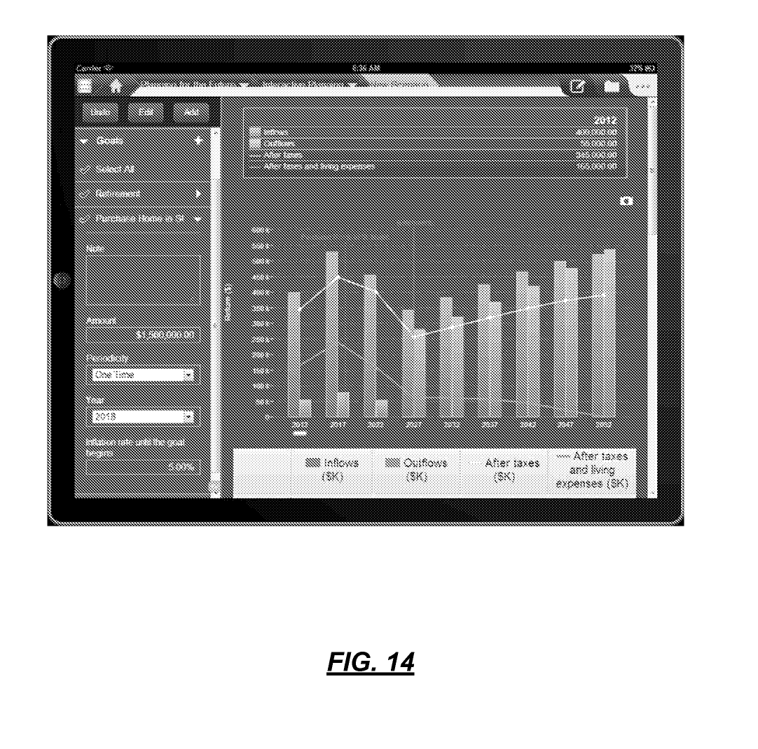

At step 418, meeting management service 120 receives a request to display the impact on the existing retirement goal of pursuing the separate goal of purchasing a retirement home in St. Martin. FIG. 14 depicts an example user interface that may be generated by service 120. As shown, when a user elects to pursue another goal such as purchasing a home, the user must enter financial information associated with the goal. In connection with the example illustrated in FIG. 14, the user enters information identifying the outflow amount associated with purchasing the home, the periodicity of the outflow, i.e., whether it is a one-time payment or monthly/yearly/etc., the date that the outflow begins (the year of purchasing the house), and the anticipated inflation rate prior to implementing the goal (purchasing the house). This financial information relating to the goal is received by service 120.

At step 420, meeting management service 120 calculates the impact of implementing the goal as specified by the individual. More particularly, service 120 calculates the value of the portfolio over time assuming the goal as specified by the individual is implemented.

At step 422, meeting management service 120 communicates data corresponding to the value of the portfolio over time assuming the goal is pursued. As shown in the right hand portion of FIG. 14, the portfolio values over time are illustrated assuming the goal of purchasing a home in St. Martins is pursued.

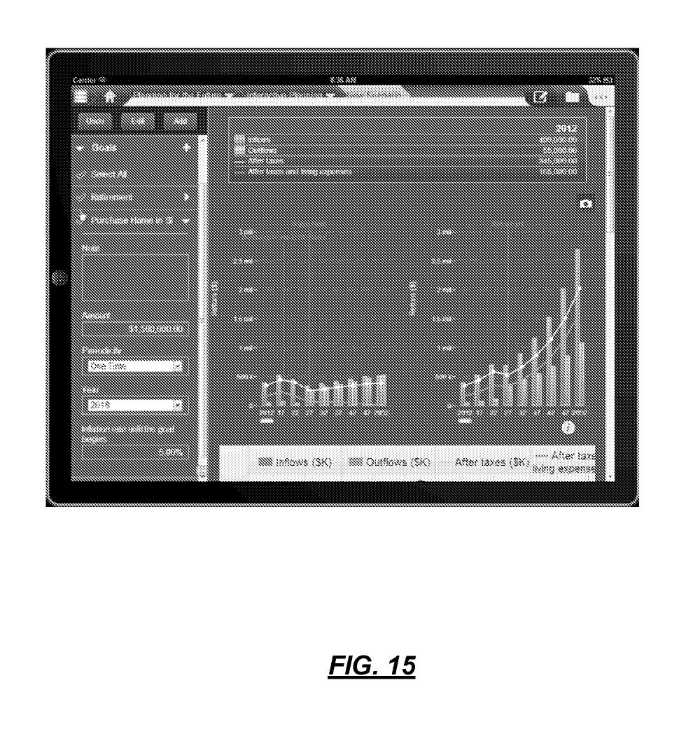

Meeting management service 120 offers the capability to simultaneously view the investment portfolio values assuming different goals are pursued. For example, upon request from an individual operating the system, service 120 may simultaneously depict charts associated with different goal sets. FIG. 15 depicts an example user interface that simultaneously depicts a chart showing the value of a portfolio during retirement assuming a vacation home in St. Martin is not purchased, and a chart showing the value of a portfolio during retirement assuming a vacation home in St. Martin is purchased. This juxtapositioning allows the meeting participants to better absorb the potential impacts of pursuing various goals that have a financial impact.

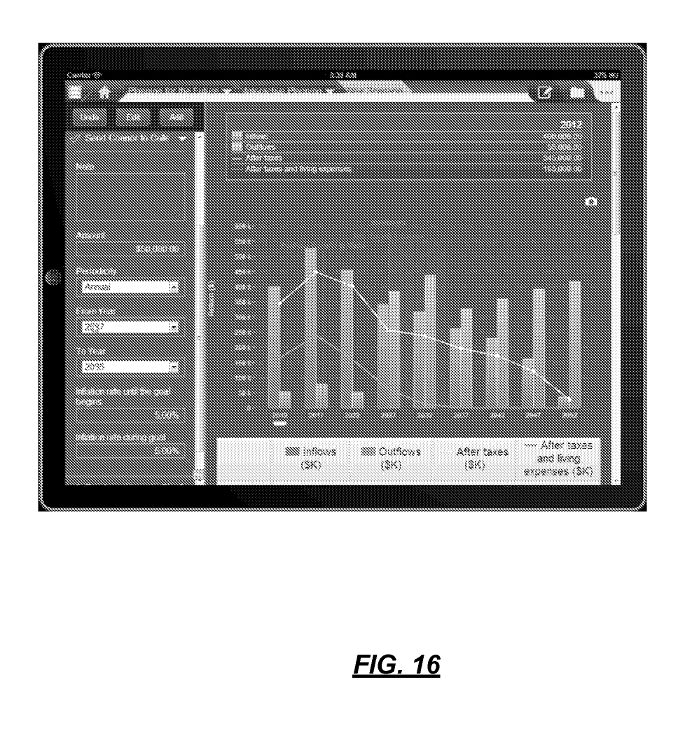

Meeting management service 120 offers great flexibility in adding goals and removing goals and considering the impact on an overall financial position. FIG. 16 depicts an example user interface presented by service 120 whereby a meeting participant may enter information about yet another goal. In the example depicted in FIG. 16, the goal is to send a child to college. The interface provides for entering information specifying the amount of the outflow, i.e., tuition and expenses for college, a periodicity of the outflow, the years over which the outflows are to occur, and anticipated values for inflation both prior to the outflows and during the period during which outflows occur. In addition to allowing different goals to be entered and applied either singly or in combination, service 120 also allows the user to create multiple independent scenarios, each with their own unique set of assumptions and related goals.

Meeting management service 120 is adapted to preserve meeting materials resulting from goal analysis. Accordingly, service 120 may receive requests to bookmark particular pages that are developed during a meeting and that illustrate various goals analysis. Also, service 120 is adapted to receive notes that may be entered in connection with a goal analysis. As described above, service 120 stores data in data store 142 identifying bookmarks and notes, and associates the notes with the particular pages and data that were displayed at the time that the note was created. It should be understood that pages that are created by meeting management service 120 in connection with an analysis of goals and any notes that are created in association with those pages are stored and available for inclusion in the meeting document that is generated by service 120.

As described above in connection with FIG. 3, meeting management service 120 generates a meeting summary document which provides a record of the meeting. The document that is generated as a result of the meeting may be stored in any number of formats. In an example scenario, the document may be stored in portable document format, i.e., pdf. In an alternative embodiment, the document may be stored as a Microsoft Word document. Service 120 may be adapted to electronically present the document to individuals such as, for example, those that participated in the meeting.

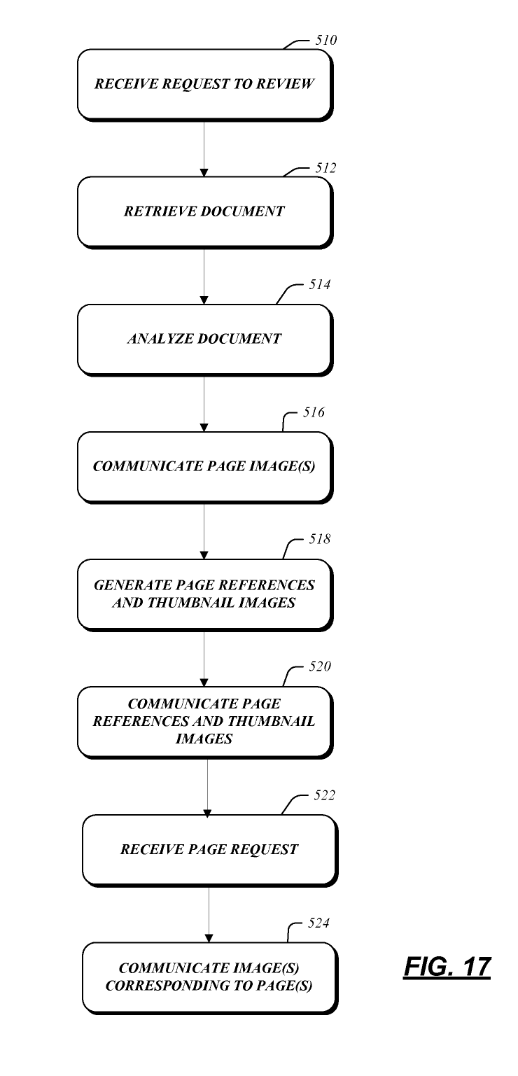

FIG. 17 depicts an example process implemented by meeting management service 120 in responding a request to review a meeting summary document. At step 510, a request to review the meeting summary document may be received. The request may be received from one of devices 110a-e and may originate from any participant in the meeting or other person that is authorized to review the document.

At step 512, meeting management service 120 retrieves the document form data store 142. At step 514, meeting management service 120 analyzes the document. In an example scenario, the service 120 may analyze the document in order to determine the number of pages in the document. The server then converts one or more pages in the document into individual image files. For example, the server may convert pages that are stored in the pdf document into image files that are formatted consistent with the portable network graphic, i.e., .png file format, or any image format consistent with the disclosure herein. The number of pages that are converted into image files may vary depending upon the particular application and may be configurable to any number of pages desired. For example, in an example scenario, five pages that are included in the electronic document may be formatted as image files. In another scenario, the system may be configured to generate image files for all pages. In an example scenario, images may be generated for the first five pages of the document. At step 516, the converted image files are then communicated to the device or individual that requested the document.

The initial set of image files that are communicated are often only a subset of all pages in the document. At step 518, meeting management service 120 generates references to all pages in the document and generates thumbnail images for all document pages. At step 520 the page references and thumbnails are communicated to the requesting device. Once the page references and thumbnails are received at the requesting device, the device may then use the page references to request additional pages from the service 120. Providing the thumbnail images allows for rapid navigation between all available pages.

At step 522, a request is received a meeting management service 120 for one or more particular pages of the document. At step 524, meeting management service 120 generates image files corresponding to each page that has been requested. The created image files are then communicated to the requesting device.

Converting pages in a document that is stored in pdf format or Word format into image files rather than downloading the source file minimizes the risk that a document containing sensitive information may be copied and/or viewed by unauthorized individuals. In some instances, converting documents into individual images and downloading images minimizes the communication bandwidth that is used in communicating the relevant document pages. Moreover, bandwidth may be conserved by staging the delivery of imaged pages to devices rather than downloading images for all pages.

Example Computing Environment

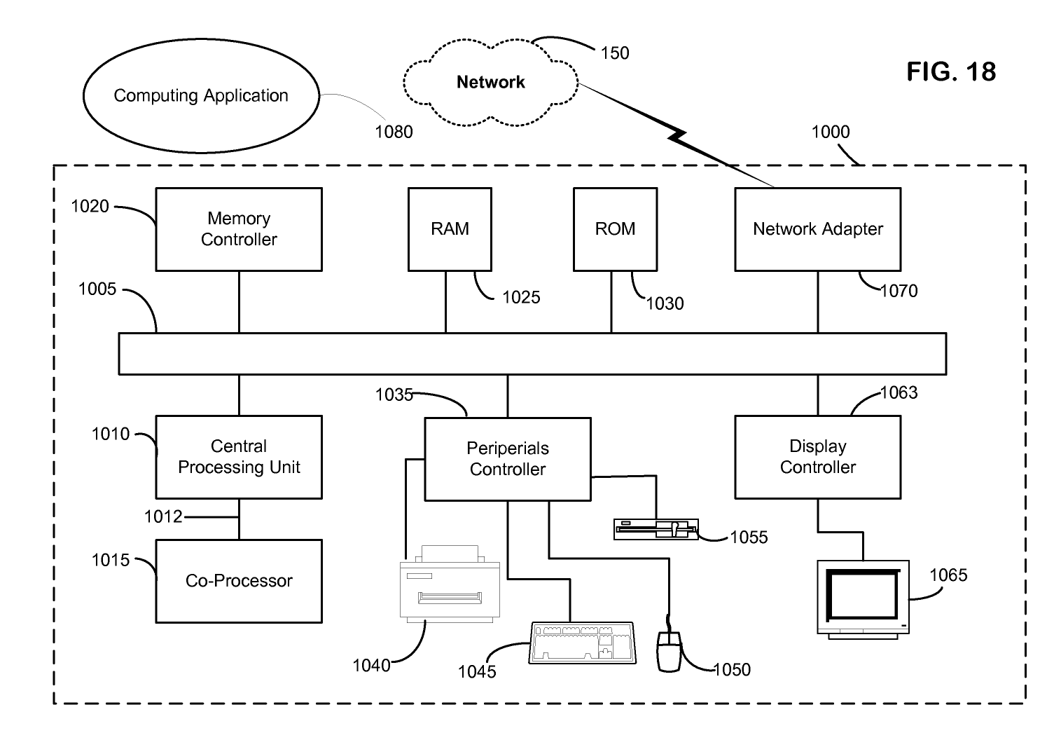

FIG. 18 depicts a block diagram of an exemplary computing system 1000 that may be used to implement the systems and methods described herein. For example, the computing system 1000 may be used to implement meeting management service 120 as well as any of devices 140, 110a-e and 112. The computing system 1000 may be controlled primarily by computer readable instructions that may be in the form of software. The computer readable instructions may include instructions for the computing system 1000 for storing and accessing computer readable instructions themselves. Such software may be executed within a central processing unit (CPU) 1010 to cause the computing system 1000 to perform the processes or functions associated therewith. In many known computer servers, workstations, personal computers, or the like, the CPU 1010 may be implemented by micro-electronic chips CPUs called microprocessors.

In operation, the CPU 1010 may fetch, decode, and/or execute instructions and may transfer information to and from other resources via a main data-transfer path or a system bus 1005. Such a system bus may connect the components in the computing system 1000 and may define the medium for data exchange. The computing system 1000 may further include memory devices coupled to the system bus 1005. According to an example embodiment, the memory devices may include a random access memory (RAM) 1025 and read only memory (ROM) 1030. The RAM 1025 and ROM 1030 may include circuitry that allows information to be stored and retrieved. In one embodiment, the ROM 1030 may include stored data that cannot be modified. Additionally, data stored in the RAM 1025 typically may be read or changed by CPU 1010 or other hardware devices. Access to the RAM 1025 and/or ROM 1030 may be controlled by a memory controller 1020. The memory controller 1020 may provide an address translation function that translates virtual addresses into physical addresses as instructions are executed.

In addition, the computing system 1000 may include a peripherals controller 1035 that may be responsible for communicating instructions from the CPU 1010 to peripherals, such as, a printer 1040, a keyboard 1045, a mouse 1050, and data a storage drive 1055. The computing system 1000 may further include a display 1065 that may be controlled by a display controller 1063. The display 1065 may be used to display visual output generated by the computing system 1000. Such visual output may include text, graphics, animated graphics, video, or the like. The display controller 1063 may include electronic components that generate a video signal that may be sent to the display 1065. Further, the computing system 1000 may include a network adaptor 1070 that may be used to connect the computing system 2000 to an external communication network such as the network 150, described above in FIG. 1.

Accordingly, applicants have disclosed exemplary embodiments of systems and methods for meeting management. The system aggregates data that may be used during the course of a scheduled meeting and allows for the customization of the data for presentation during the scheduled meeting. The system communicates the customized data to meeting participants for discussion and review. The system also accepts inputs during the meeting that define additional meeting information such as bookmarked pages and views that were reviewed during the meeting. The inputs may further define notes reflecting discussions held during the meeting. The system stores information reflecting the bookmarks and notes that were made during the meeting. After the meeting has concluded, the data that was presented during the meeting as well as the bookmarks and notes that were presented during the meeting may be reviewed and selected for inclusion in an electronic document. The document may then be electronically communicated to the participants in the meeting for reference at a later time.

It will be appreciated that while illustrative embodiments have been disclosed, the scope of potential embodiments is not limited to those explicitly set out. For example, while the system has been described with reference to particular scenarios involving meetings relating to wealth management, the envisioned embodiments extend beyond a particular industry or meeting scenario to include industries such as accounting, technology, education, and management.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Those skilled in the art will appreciate that the disclosed embodiments may be provided as a subscription web based solution that anyone with an internet connection may log on and begin using the system. Large corporations may internally monitor multiple users within an exemplary embodiment platform to direct media placement. The potential embodiments may be developed and programmed in any web based technology platform. Alternatively, a potential embodiment may be implemented as a standalone application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for managing meeting materials, comprising:
receiving content that may be presented during a meeting;
receiving inputs prior to the meeting specifying meeting information from the content for presentation during the meeting;
storing data identifying the specified meeting information from the content for presentation during the meeting;
communicating the specified meeting information for use in the meeting;
receiving inputs during the meeting creating additional meeting information;
storing data identifying the created additional meeting information;
receiving inputs specifying at least portions of the specified meeting information and the created additional meeting information for incorporation into a document file; and
generating a document file consistent with the inputs specifying at least portions of the specified meeting information and the created additional meeting information for incorporation into a document file.

2. The method of claim 1, wherein receiving content that may be presented during a meeting comprises receiving data from a computing application for managing investment portfolios.

3. The method of claim 1, wherein receiving content that may be presented during a meeting comprises receiving data relating to finances of one or more individuals.

4. The method of claim 1, wherein receiving inputs prior to the meeting specifying meeting information from the content for presentation during the meeting comprises: receiving inputs specifying particular pages from a plurality of pages of information for presentation during the meeting.

5. The method of claim 1, further comprising prior to the meeting receiving inputs specifying additional information for presentation during the meeting.

6. The method of claim 5, wherein receiving inputs specifying additional information for presentation during the meeting comprises receiving inputs specifying at least one note for presentation during the meeting.

7. The method of claim 6, further comprising storing in a database an association between the specified at least one note for presentation during the meeting and an identifier corresponding to the meeting.

8. The method of claim 5, wherein receiving inputs specifying additional information for presentation during the meeting comprises receiving inputs specifying at least one bookmark identifying data for presentation during the meeting.

9. The method of claim 8, further comprising storing in a database an association between the specified at least one bookmark and an identifier corresponding to the meeting.

10. The method of claim 1, wherein storing data identifying the specified meeting information from the content for presentation during the meeting, comprises storing in a database an association between the specified meeting information and an identifier corresponding to the meeting.

11. The method of claim 1, wherein communicating the specified meeting information for use in the meeting comprises communicating the specified meeting information for receipt at a mobile device.

12. The method of claim 1, wherein receiving inputs during the meeting creating additional meeting information comprises receiving inputs during the meeting specifying at least one note.

13. The method of claim 12, wherein storing data identifying the created additional meeting information comprises storing in a database an association between the specified at least one note and an identifier corresponding to the meeting.

14. The method of claim 12, wherein storing data identifying the created additional meeting information further comprises storing in a database an association between the specified at least one note and at least one identifier corresponding to a page.

15. The method of claim 1, wherein receiving inputs during the meeting creating additional meeting information comprises receiving inputs during the meeting specifying at least one bookmark.

16. The method of claim 15, wherein storing data identifying the created additional meeting information comprises storing in a database an association between the specified at least one bookmark and an identifier corresponding to the meeting.

17. The method of claim 15, wherein storing data identifying the created additional meeting information further comprises storing in a database an association between the specified at least one bookmark and at least one identifier corresponding to a page.

18. The method of claim 1, wherein receiving inputs specifying at least portions of the specified meeting information and the created additional meeting information for incorporation into a document file comprises receiving inputs identifying particular pages for incorporation into a document file.

19. The method of claim 18, wherein receiving inputs identifying particular pages for incorporation into a document file comprises receiving inputs identifying particular pages associated with at least one of a note and a bookmark.

20. The method of claim 1, wherein generating a document file consistent with the inputs specifying at least portions of the specified meeting information and the created additional meeting information for incorporation into a document file comprises accessing a database to identifying at least portions of the specified meeting and the created additional meeting information.

21. A computer-implemented method for financial planning, comprising:
identifying an investment portfolio;
receiving input specifying a financial goal, the goal including a financial outflow;
calculating an impact on the investment portfolio of implementing the specified goal; and
communicating an output depicting the impact on the investment portfolio of implementing the specified goal.

22. The method of claim 21, wherein identifying an investment portfolio comprises identifying an existing portfolio.

23. The method of claim 21, wherein identifying an investment portfolio comprises receiving inputs defining an investment portfolio.

24. The method of claim 23, wherein receiving inputs defining an investment portfolio comprises receiving inputs identifying values for an existing value of a portfolio and at least one of current income; household expenses; rate of return; tax rate; and anticipated inflation rate.

25. The method of claim 24, wherein receiving inputs defining an investment portfolio further comprises receiving inputs defining one or more of the following: year of retirement; anticipated retirement goal; income during retirement; and length of retirement.

26. The method of claim 21, wherein receiving input specifying a financial goal, the goal including a financial outflow, comprises: receiving input defining a financial outflow amount; receiving input defining a periodicity of the outflow; and receiving input defining a time period at which the outflow is to take place.

27. The method of claim 26, wherein receiving input defining a financial outflow amount comprises receiving an input defining one or more of an outflow for use in retirement, an outflow relating to a purchase, an outflow relating to donations to charity.

28. The method of claim 26, wherein receiving input defining a periodicity of the outflow comprises receiving an input identifying the periodicity as a single year.

29. The method of claim 21, wherein calculating the impact on the investment portfolio of implementing the specified goal comprises calculating an estimated value of the portfolio at one or more future times in view of the financial outflow.

30. The method of claim 21, wherein communicating an output depicting the impact on the investment portfolio of implementing the specified goal comprises communicating one or more charts identifying values at one or more points in time of the investment portfolio.

31. The method of claim 21, further comprising receiving input specifying at least a second financial goal, each of the at least a second financial goal including a financial outflow,
wherein calculating an impact on the investment portfolio of implementing the specified goal comprises calculating an impact on the investment portfolio of implementing the at least a second financial goal, and
wherein communicating an output depicting the impact on the investment portfolio of implementing the specified goal comprises communicating an output depicting the impact on the investment portfolio of implementing the at least a second financial goal.

32. The method of claim 31, further comprising receiving an input selecting a goal for removal from consideration,
wherein calculating an impact on the investment portfolio of implementing the specified goal comprises calculating an impact on the investment portfolio absent the selected goal for removal from consideration.

33. The method of claim 21, further comprising receiving inputs specifying at least one note for presentation during a meeting.

34. The method of claim 33, further comprising storing in a database an association between the specified at least one note and an identifier corresponding to the meeting.

35. The method of claim 33, further comprising receiving inputs specifying at least one bookmark identifying data for presentation during a meeting.

36. The method of claim 35, further comprising storing in a database an association between the specified at least one bookmark and an identifier corresponding to the meeting.

37. A computer-implemented method for communicating a document, comprising:
receiving a request for a document, the document stored as a portable document format file;
analyzing the document;
converting pages in the document into image files;
communicating the image files.

38. The method of claim 37, wherein analyzing the document comprises analyzing the portable document format file and identifying the number of pages in the document.

39. The method of claim 37, wherein: converting pages in the document into image files comprises converting a first five pages of the document into five image files, and communicating the image files comprises communicating the five image files.

40. The method of claim 37, further comprising communicating references to all pages in the document.

41. The method of claim 40, further comprising creating thumbnail images for all pages in the document and communicating all thumbnails

42. The method of claim 41, further comprising receiving a request for additional pages of the document, and in response to the request for additional pages, generating image files for the requested additional pages and communicating the generated images files.

43. The method of claim 41, wherein converting pages in the document into image files comprises converting pages in the document into portable network graphic format files.
